(19) United States
(12) Patent Application Publication
(10) Pub. No.: US 2023/0108555 A1
(43) Pub. Date: Apr. 6, 2023

(54) LAYOUT CHECK SYSTEM USING FULL-CHIP LAYOUT AND LAYOUT CHECK METHOD USING THE SAME

(71) Applicant: Samsung Electronics Co., Ltd., Suwon-si (KR)

(72) Inventors: Kyungmi YEOM, Yongin-si (KR); Alexander SHMIDT, Suwon-si (KR); Anthony Pierre Gerard PAYET, Seongnam-si (KR); Hyoshin AHN, Seoul (KR); Inkook JANG, Seoul (KR)

(73) Assignee: Samsung Electronics Co., Ltd., Suwon-si (KR)

(21) Appl. No.: 17/950,375

(22) Filed: Sep. 22, 2022

(30) Foreign Application Priority Data
Oct. 5, 2021 (KR) 10-2021-0131975

(51) Int. Cl. G06F 30/398; G06F 30/392

(52) U.S. Cl. CPC G06F 30/398; G06F 30/392

(57) ABSTRACT

A layout check method includes generating a layout shell structure by preprocessing a full-chip layout, generating a process condition model by preprocessing at least one process condition, extracting a stress simulation value of the layout shell structure by performing a stress simulation based on the layout shell structure and on the process condition model, and extracting statistics data based on the stress simulation value of the layout shell structure, wherein the layout shell structure and the process condition model are configured to have a dimension which is greater than two dimensions and less than three dimensions.

### CROSS-REFERENCE TO RELATED APPLICATION

This application is based on and claims priority under 35 U.S.C. § 119 to Korean Patent Application No. 10-2021-0131975, filed on Oct. 5, 2021, in the Korean Intellectual Property Office, the disclosure of which is incorporated by reference herein in its entirety.

### BACKGROUND

Inventive concepts relate to a layout check system and/or a layout check method, and more particularly, to a layout check system using a full-chip layout and/or a layout check method.

Much effort has been made to increase a capacity of semiconductor devices, decrease the manufacturing cost of semiconductor devices, and/or increase the degree of integration of semiconductor devices. Particularly, the degree of integration of semiconductor devices is one of the main factors for determining the price of products. Because the degree of integration of semiconductor devices is mainly determined based on an area occupied by a unit cell, it is very important to efficiently design a layout of semiconductor devices. Generally, in designing a layout of semiconductor devices by using a layout design tool, much time and/or many iterations of trial-and-errors are performed, and thus, it is very important to shorten a layout design time also. Therefore, it is required or desired to develop technology which shortens a check time for designing a layout and checks a layout so that a layout error does not occur, or is less likely to occur, in a process step later.

### SUMMARY

Inventive concepts provide a layout check system and/or a layout check method, which check a layout by using a full-chip layout, and thus, accurately check a layout error.

The objects of inventive concepts are not limited to the aforesaid, but other objects not described herein will be clearly understood by those of ordinary skill in the art from descriptions below.

According to some example embodiments, there is provided a layout check method including generating a layout shell structure by preprocessing a full-chip layout, generating a process condition model by preprocessing at least one process condition, extracting a stress simulation value of the layout shell structure by performing a stress simulation based on the layout shell structure and the process condition model, and extracting statistics data based on the stress simulation value of the layout shell structure, wherein the layout shell structure and the process condition model are configured to have a dimension which is greater than two dimensions and less than three dimensions.

Alternatively or additionally, according to some example embodiments, there is provided a layout check method including generating a tile layout by disassembling a full-chip layout into a plurality of tiles, generating a layout shell structure having a virtual height on each of the plurality of tiles, generating a process condition model having the virtual height by using at least one process condition and a three-dimensional simulation model, generating a plurality of target shell structures by tile units by applying the process condition model to the layout shell structure, and extracting stress simulation values respectively corresponding to the plurality of target shell structures by performing a stress simulation on each of the plurality of target shell structures.

According to some example embodiments, there is provided a layout check system including a sub-memory configured to store data and computer-readable instructions, the data including a full-chip layout, process conditions, and a three-dimensional simulation model and the instructions including execution instructions of a tool for performing a stress simulation, a main memory configured to store the tool for performing the stress simulation, and a processor configured to generate a layout shell structure having a virtual height based on a tile layout corresponding to the full-chip layout being disassembled into a plurality of tiles, generate a process condition model having a virtual height based on at least one of the process condition and the three-dimensional simulation model, and perform the stress simulation by using a target shell structure generated by applying the process condition model to the layout shell structure.

### BRIEF DESCRIPTION OF THE DRAWINGS

Embodiments of inventive concepts will be more clearly understood from the following detailed description taken in conjunction with the accompanying drawings in which:

FIG. 1 is a flowchart illustrating a method of designing and manufacturing a semiconductor device, according to some example embodiments;

FIG. 2 is a flowchart of a layout check operation according to some example embodiments;

FIG. 3 is a flowchart for describing a layout preprocessing operation according to some example embodiments;

FIG. 4 is a diagram for describing a layout preprocessing operation according to some example embodiments;

FIG. 5 is a flowchart for describing a process condition preprocessing operation according to some example embodiments;

FIG. 6 is a diagram for describing a process condition preprocessing operation according to some example embodiments;

FIG. 7 is a flowchart for describing a processing operation according to some example embodiments;

FIG. 8 is a diagram for describing a processing operation according to some example embodiments;

FIG. 9 is a flowchart for describing a pattern analysis operation according to some example embodiments;

FIG. 10 is a diagram for describing a pattern analysis operation according to some example embodiments;

FIG. 11 is a flowchart for describing a statistics analysis operation according to some example embodiments;

FIGS. 12A to 12D are diagrams for describing statistics data according to some example embodiments; and

FIG. 13 is a block diagram of a layout check system according to some example embodiments.

### DETAILED DESCRIPTION OF VARIOUS EXAMPLE EMBODIMENTS

Hereinafter, various example embodiments will be described in detail with reference to the accompanying drawings. In the drawings, for convenience of illustration, only some elements may be illustrated. In providing a description with reference to the drawings, like reference numerals refer to like elements, and their repeated descriptions thereof are omitted.

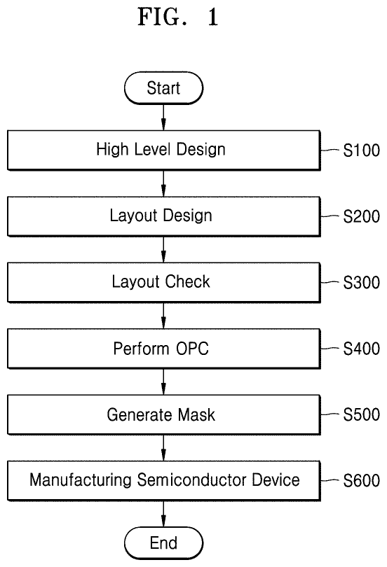

FIG. 1 is a flowchart illustrating a method of designing and/or manufacturing a semiconductor device, according to some example embodiments.

Referring to FIG. 1, the method of designing and manufacturing a semiconductor device may include operations S100 to S600, performed in the listed order or performed in other orders not necessarily as illustrated in FIG. 1, with one or more operations performed iteratively or repeatedly.

In operation S100, a high level design of the semiconductor device may be performed. A high level design may correspond to an idea of a product adopted and to an integrated circuit based on the adopted idea is described in a computer language. For example, a semiconductor integrated circuit may be described in a high level language such as a C programming language and/or another programming language such as a hardware description language. Circuits designed by a high level design may be expressed by a register transfer level (RTL) coding and/or simulation in more detail. A code generated by the RTL coding may be converted into a netlist and may be synthesized into a semiconductor device. A synthesized schematic circuit may be checked by a simulation tool, and an adjustment process may accompany the same.

In operation S200, a layout design for implementing a logically completed semiconductor integrated circuit on a silicon substrate may be performed. A layout may be configured to place layout patterns such as polygons having various shapes and/or sizes in and at shapes and/or positions needed or used for configuring a circuit of a semiconductor device. A layout design may denote a process of defining a size and/or a shape of a pattern for configuring metal wirings and transistors which are to be actually fabricated on the silicon substrate.

The layout design may be performed based on the schematic circuit synthesized in operation S100 and/or a netlist corresponding thereto. The layout design may include a process of placing various standard cells provided in a cell library on the basis of a designated design rule and a routing process of connecting the standard cells. The cell library may include information about one or more of an operation, a speed, and power consumption of a standard cell.

For example, a user may search for and select a suitable inverter from among inverters predefined in the cell library. Circuit patterns such as a P-channel metal-oxide-semiconductor (PMOS), an N-channel metal-oxide-semiconductor (NMOS), an N-WELL, a gate electrode, and metal wirings, contacts, and vias to be disposed thereon may be appropriately disposed based on the selected inverter. Subsequently, routing may be performed on selected and disposed standard cells. In detail, upper wirings (routing wirings) may be disposed on the disposed standard cells. As routing is performed, the disposed standard cells may be connected to one another on the basis of a design. Placing and routing of standard cells may at least be partially automatically performed by a placing and routing tool.

In operation S300, layout check may be performed. The layout check may denote or correspond to a process of checking whether a designed layout conforms with a design rule. The layout check may include one or more of a design rule checking (DRC) process of checking whether a layout conforms with the design rule, an electronical rule checking (ERC) of checking whether the layout is normal without being electrically disconnected, and a layout vs schematic (LVS) process of checking whether the layout matches a gate level netlist.

Particularly, the DRC process may at least partially predict whether a reproducible integrated circuit is capable of being manufactured based on a designed layout. The DRC process may represent whether the designed layout is at least partially capable of being applied to a manufacturing process, or (or additionally) may represent, as at least one parameter, a possibility that the designed layout is applied to the manufacturing process. The DRC process may detect one or more points having a possibility that an error occurs in the designed layout. A certain point of a layout having a possibility of the error occurring may be referred to as a hot spot.

In operation S300 according to some example embodiments, layout check may be performed by using a full-chip layout. In a case where check is performed by using only a sampled layout, a hot spot, which is not detected in operation S300, may be detected in operation S600, which is performed subsequently. For example, in a case where operation S300 is performed by using the sampled layout, the sampled layout may be affected by an etch bias on the basis of a shape and/or a size of an adjacent pattern in operation S600, but a portion of a hot spot may not be detected in operation S300. However, in a case where layout check is performed by using the full-chip layout, all or almost all hot spots capable of occurring in the designed layout may be previously detected in operation S300.

In operation S400, optical proximity correction (OPC) may be performed. Distortion, which is capable of occurring in performing a photolithography process in a subsequent operation on layout patterns generated through operations S200 and S300, may be at least partially corrected by performing the OPC. For example, distortion such as refraction and/or process effects caused by a characteristic of light in performing a photolithography process in a subsequent operation (for example, S600), may be corrected by performing the OPC. As the OPC is performed, shapes and/or positions of designed layout patterns may be finely biased.

In operation S500, a photomask may be manufactured or cut based on a layout biased by the OPC. The photomask may be manufactured by a manner which represents layout patterns by using a chrome layer coated on a glass substrate, for example with an electron beam (e-beam) writing technique.

In operation S600, a semiconductor device may be manufactured or fabricated by using the photomask (alone or in conjunction with one or more other photomasks representing one or more other layers of the semiconductor device). Various exposure processes and etching processes may be repeated in a process of manufacturing a semiconductor device. Therefore, shapes of patterns configured through a layout design may be sequentially formed on the silicon substrate.

According to some example embodiments, by performing layout check by using the full-chip layout in operation S300, a pattern defect of a wafer occurring after a pattern defect of the photomask or an exposure process may be identified and at least partially corrected so as to be reduced in likelihood of occurrence on the wafer. Also, the number of revisions of the photomask may decrease, and thus, the manufacturing cost of a semiconductor device may be reduced. Hereinafter, operation S300 will be described in more detail.

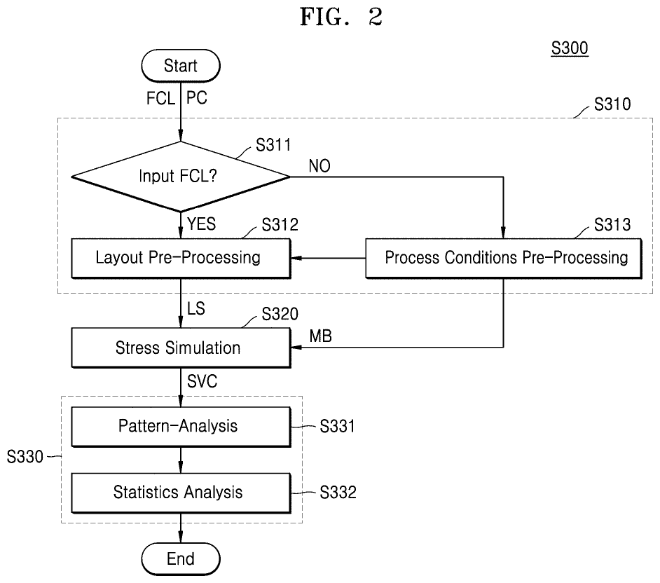

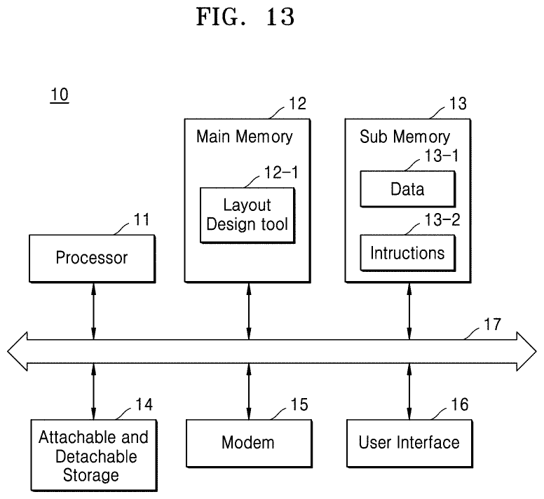

FIG. 2 is a flowchart of a layout check operation according to some example embodiments. In detail, FIG. 2 is a diagram for describing layout check operation S300 of FIG. 1. The layout check operation S300 may be performed by a layout check system 10, which will be described below with reference to FIG. 13. Hereinafter, layout check operation S300 will be described with reference to FIG. 1.

Referring to FIG. 2, layout check operation S300 may include operations S310 to S330.

Operation S310 may include operations S311 to S313. Operation S310 may be referred to as a preprocessing operation. In operation S310, a layout shell structure LS and a process condition model MB each having a virtual height may be generated, with both the layout shell structure LS and the process condition model MB being based on a full-chip layout FCL and/or a process condition PC.

In operation S311, whether data of one of the full-chip layout FCL and the process condition PC is input may be determined. The full-chip layout FCL and the process condition PC may be input to the layout check system 10, which will be described below with reference to FIG. 13. The full-chip layout FCL and the process condition PC may be stored in some hardware such as at least one of a modem (15 of FIG. 13) or an attachable and detachable storage device (14 of FIG. 13), which will be described below with reference to FIG. 13. The full-chip layout FCL may be data in one or more standard formats, such as but not limited to a graphics design system (GDSii) format; however, example embodiments are not limited thereto.

The full-chip layout FCL may be raw data where a layout is not sampled. The process condition PC may include one or more of various process conditions, such as one or more of a voltage, a current, a temperature, a time, a structure, and a material, which are applied in implementing a semiconductor device on an actual wafer. For example, the process condition PC may include at least one of a process temperature, a process time, a structure of a semiconductor device in performing a process, and a material included in the semiconductor device, which are applied in manufacturing an actual semiconductor device by using the layout designed in operation S600 of FIG. 1. In operation S311, when input data is the full-chip layout FCL, operation S312 may be performed, and when the input data is at least one process condition PC, operation S313 may be performed.

In operation S312, the full-chip layout FCL may be processed or preprocessed. The full-chip layout FCL may be preprocessed by a processor (11 of FIG. 13), which will be described below with reference to FIG. 13. Therefore, a layout shell structure LS having a virtual height may be generated. The full-chip layout FCL may be two-dimensional (2D) data, and the layout shell structure LS may be data of a dimension greater than two dimensions and less than three dimensions; e.g. the layout shell structure LS may be a wire-frame structure, e.g. a net structure or a non-planar graph structure. The layout shell structure LS may be formed based on a mesh size MS output in operation S313.

In operation S313, the process condition PC may be preprocessed. The process condition PC may be preprocessed by a processor (11 of FIG. 13), which will be described below with reference to FIG. 13. Therefore, the process condition model MB may be generated, and the mesh size MS may be determined.

The process condition model MB may include a simulation model, which is generated by applying the process condition PC to the layout shell structure LS. The process condition model MB may be data of a dimension greater than two dimensions and less than three dimensions, may be a wire-frame structure, e.g. a net structure or a non-planar graph structure. The process condition model MB may include information about intrinsic stress and/or other physical properties.

The mesh size MS may be determined based on the process condition model MB. The mesh size MS may denote a unit for performing a stress simulation in a subsequent operation. For example, the stress simulation may be performed based on the mesh size MS in subsequent operation S320. Therefore, a stress value may be extracted based on the mesh size MS.

Operation S312 may be performed in parallel with operation S313. However, inventive concepts is not limited thereto, and operation S313 may be first performed or only a portion of operation S312 may be first performed. The layout shell structure LS and the process condition model MB each generated through operation S310 may be used in stress simulation operation S320 subsequent thereto.

In operation S320, a target shell structure TS may be generated by using the layout shell structure LS and the process condition model MB, and a stress simulation may be performed based on the target shell structure TS. Therefore, a stress simulation value SVC corresponding to a full-chip layout may be extracted. The stress simulation value SVC may include one or more of coordinates of a position at which the stress occurs, stress, strain, and displacement.

Operation S320 may be performed by a processor (11 of FIG. 13) by using a layout design tool (12-1 of FIG. 13) stored in a main memory (12 of FIG. 13), which will be described below with reference to FIG. 13. Operation S320 may be referred to as a simulation operation.

Operation S330 may include operations S331 and S332. Operation S330 may be preprocessed by a processor (11 of FIG. 13), which will be described below with reference to FIG. 13. Operation S330 may be referred to as a post-processing operation. Statistics data may be extracted based on the stress simulation value SVC in operation S330.

In operation S331, a local layout pattern may be extracted based on the stress simulation value SVC. Also, the local layout pattern may be analyzed, and thus, may be categorized by category units. The local layout pattern may be defined by dividing the target shell structure TS according to a predetermined and/or dynamically or variably determined condition. For example, the local layout pattern may denote one of 100 divided square pieces of the target shell structure TS. A local layout pattern having the same shape may be categorized as one category. Operation S331 may be optionally selected.

In operation S332, statistics data of a stress value may be generated based on a categorized local layout pattern or the stress simulation value SVC. When operation S331 is performed, statistics data may be generated based on the categorized local layout pattern and may be a histogram categorized by images of the local layout pattern. For example, the statistics data generated when operation S331 is performed may include data corresponding to a portion of the full-chip layout. When operation S331 is omitted, statistics data may be generated based on the stress simulation value SVC and may be a graph or a histogram corresponding to the full-chip layout.

The layout check method according to some example embodiments may provide a graph and/or a histogram corresponding to all data, thereby providing a layout check system and a layout check method, which accurately or more accurately check a layout defect and shorten a layout check time. Hereinafter, each operation of operation S300 will be described in more detail.

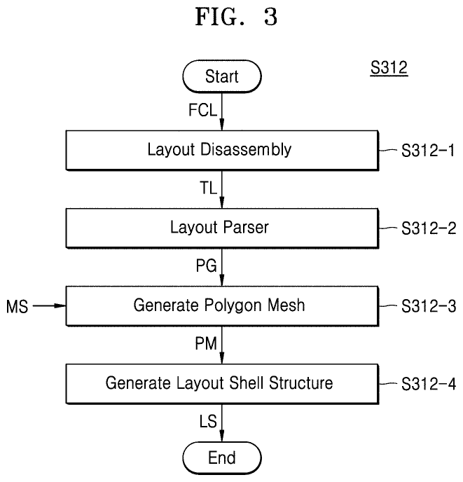

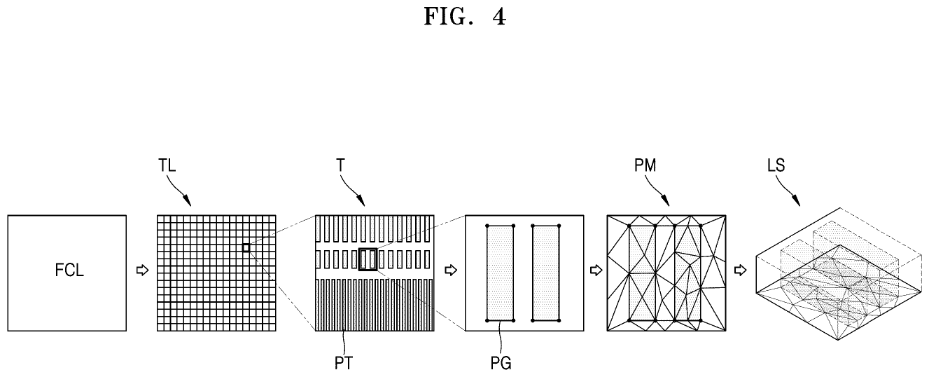

FIGS. 3 and 4 are diagrams for describing a layout preprocessing operation according to some example embodiments. In detail, FIG. 3 is a flowchart for describing layout preprocessing operation S312 of FIG. 2, and FIG. 4 is a diagram for describing layout preprocessing operation S312 of FIG. 2. Hereinafter, a layout preprocessing operation according to some example embodiments will be described with reference to FIGS. 1 and 2, and repeated descriptions thereof are omitted.

Referring to FIGS. 3 and 4, layout preprocessing operation S312 may include operations S312-1 to S312-4.

In operation S312-1, a tile layout TL may be generated by fracturing or disassembling a full-chip layout FCL into a plurality of tiles. For example, the full-chip layout FCL may be tiled, and thus, the tile layout TL may be omitted. Small-unit layouts configuring the tile layout TL may be referred to as a tile T. Each of a plurality of tiles T may include the same or different layout patterns PT. A size and/or a shape of each tile T may be the same. Each tile T may be rectangular, e.g. may be square; however, example embodiments are not limited thereto.

In operation S312-2, parsing may be performed on each tile T. As parsing is performed, each tile T may be converted into a coding language, and a node and coordinate information may be extracted from the layout pattern PT included in each tile T. Based on the extracted node and coordinate information, a polygon PG may be extracted from each tile T. The polygon PG may denote a polygon (for example, a rectangle, a triangle, a tetragon, a pentagon, etc.) connecting nodes; each polygon PG may have edges meeting at angles of 90 degrees; however, example embodiments are not limited thereto.

In operation S312-3, a triangulation or a mesh may be generated based on the polygon PG. Therefore, a polygon mesh PM may be generated for each tile T. A mesh may be generated based on the mesh size MS determined in operation S313. The polygon mesh PM may denote one object including a plurality of polygons. For example, as illustrated in FIG. 4, the polygon mesh PM may be configured with a plurality of polygons connecting nodes of the layout pattern PT. The polygon mesh PM may be 2D data.

In operation S312-4, a layout shell structure LS based on the polygon mesh PM may be generated. The layout shell structure LS may be generated by assigning a virtual height to the polygon mesh PM. The virtual height may be determined based on a mesh included in the polygon mesh PM. The layout shell structure LS may be data of a dimension greater than two dimensions and less than three dimensions, e.g. may have a wire-frame structure.

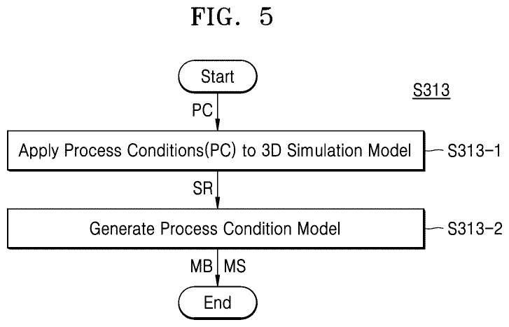

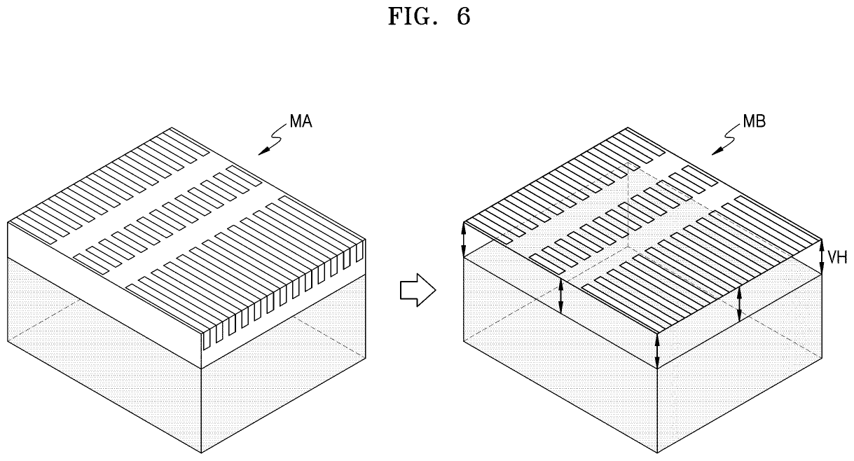

FIGS. 5 and 6 are diagrams for describing a process condition preprocessing operation according to some example embodiments. In detail, FIG. 5 is a flowchart for describing layout preprocessing operation S313 of FIG. 2, and FIG. 6 is a diagram for describing layout preprocessing operation S313 of FIG. 6. Hereinafter, a layout condition preprocessing operation according to some example embodiments will be described with reference to FIGS. 1 to 4, and repeated descriptions thereof are omitted.

Referring to FIGS. 5 and 6, process condition preprocessing operation S313 may include operations S313-1 and S313-2.

In operation S313-1, at least one process condition PC may be applied to a simulation model MA. The simulation model MA may be a portion of data (13-1 of FIG. 13) stored in a sub-memory (13 of FIG. 13) in the layout check system 10, which will be described below with reference to FIG. 13. The simulation model MA may include a model representing a 3D shape of a semiconductor device embedded in a 3D space. The simulation model MA may include a highly advanced semiconductor model. The simulation model MA may include a 3D model for simulating a stress value based on the process condition PC. As at least one process condition PC is applied to the simulation model MA, a simulation value SR may be extracted. The simulation value SR may include information about intrinsic stress and/or about physical properties.

In operation S313-2, a process condition model MB may be generated based on the simulation value SR, and a mesh size MS may be determined based on the process condition model MB. The mesh size MS may denote a unit for performing a stress simulation in a subsequent operation. The mesh size MS may be used in generating the layout shell structure LS in operation S312-4.

The process condition model MB may be configured to calculate a result value such as the simulation value SR extracted from the simulation model MA. The process condition model MB may be or may include a model which has the same structure as that of the simulation model MA and a dimension differing from that of the simulation model MA. For example, the simulation model MA may have a dimension of three, while the process condition model MB may have a wireframe and have a dimension less than three. The process condition model MB may have a virtual height VH. The virtual height VH may denote a height corresponding to the simulation model MA. The process condition model MB may include a model having a dimension which is greater than two dimensions and less than three dimensions.

Therefore, in a case where a stress simulation is performed by using the process condition model MB, a stress simulation may be performed more faster than a case where a stress simulation is performed by using the simulation model MA. For example, the process condition model MB may include a model which represents the simulation model MA, which is a more advanced model than the process condition model MB, as a dimension and calculates the same simulation value SR. The process condition model MB may include a simulation model optimized or at least partially optimized or improved for subsequent stress simulation operation S320. Accordingly, a time to model and modify and improve a photomask for use in fabrication of a semiconductor device may be reduced, and/or a yield of the semiconductor device may be improved, when using a process condition model MB having a dimension less than three and more than two, with a dimension corresponding to a wire frame and/or a nonplanar graph.

Operation S312 may be performed in parallel with operation S313. However, inventive concepts is not limited thereto, and operation S313 may be first performed or only a portion of operation S312 may be first performed. Each of the layout shell structure LS and the process condition model MB may be generated through operations S312 and S313.

According to some example embodiments, one or both of operation S312 or operation S313 may be omitted. For example, when only a process condition is changed, only operation S313 may be newly performed, and the layout shell structure LS may be read from a database or a sub-memory (13 of FIG. 13), which will be described below with reference to FIG. 13. When only a layout is changed, only operation S312 may be newly performed, and the process condition model MB may be read from a sub-memory (13 of FIG. 13), which will be described below with reference to FIG. 13.

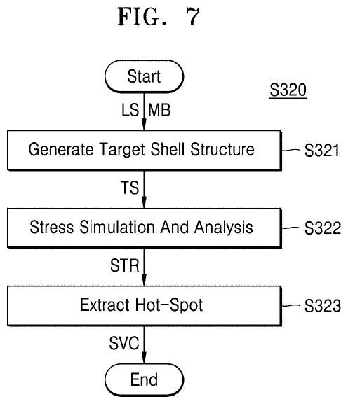

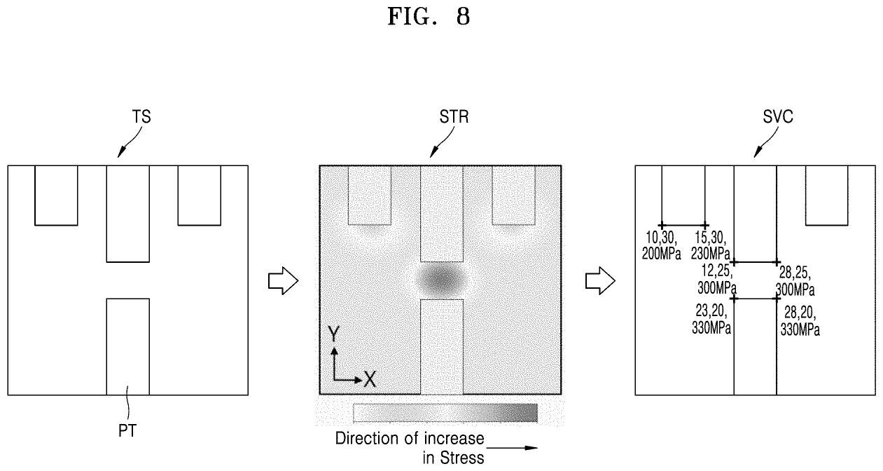

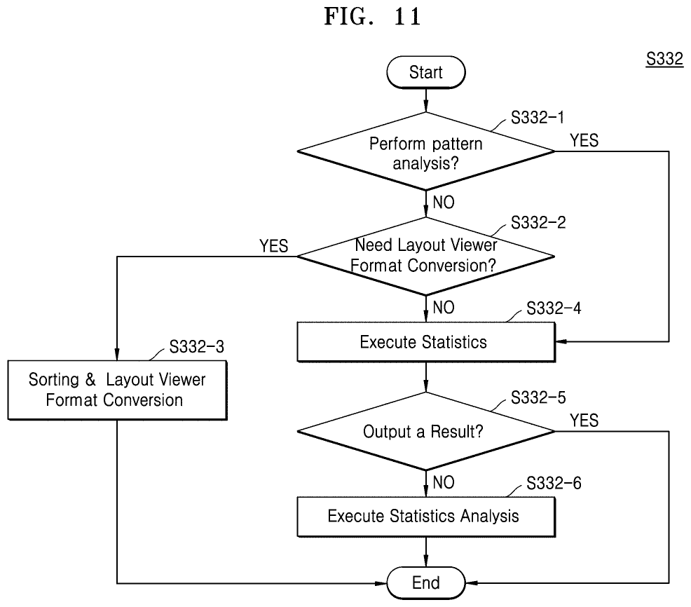

FIGS. 7 and 8 are diagrams for describing a processing operation according to some example embodiments. In detail, FIG. 7 is a flowchart for describing stress simulation operation S320 of FIG. 2, and FIG. 8 is a diagram of a shell structure illustrated for describing stress simulation operation S320 of FIG. 2 in a state where a virtual height is omitted. FIG. 8 may be data which is converted into a layout viewer file through operation S332-3 described below with reference to FIG. 11 and illustrated through a layout viewer, but for convenience of description, FIG. 8 will be described in conjunction with FIG. 7. Hereinafter, a processing operation according to some example embodiments will be described with reference to FIGS. 1 to 6, and repeated descriptions thereof are omitted.

Referring to FIGS. 7 and 8, stress simulation operation S320 may include operations S321 to S323. Stress simulation operation S320 may be performed by tile (T of FIG. 4) units. Stress simulation operation S320 may be performed simultaneously on each of a plurality of tiles.

In operation S321, a target shell structure TS may be generated based on a layout shell structure LS and a process condition model MB. The target shell structure TS may be generated by applying the process condition model MB to the layout shell structure LS.

In operation S322, a stress simulation for extracting a stress value may be performed by using the target shell structure TS, and thus, stress based thereon may be analyzed. A stress simulation may be performed by a processor (11 of FIG. 13) by using a layout design tool (12-1 of FIG. 13) stored in a main memory (12 of FIG. 13), which will be described below with reference to FIG. 13. The stress simulation may be performed by mesh size MS units determined in operation S313-2.

A stress simulation result STR extracted by performing the stress simulation may include a stress value and a position of the target shell structure TS. As illustrated in FIG. 8, the stress simulation result STR may be referred to as a color and/or a brightness difference in the target shell structure TS. For example, a position at which a stress value is relatively high may be illustrated in red or a relatively dark color, and a position at which a stress value is low may be illustrated in green or a relatively bright color. However, inventive concepts is not limited thereto, and a color based on a stress value may be variously defined, for example by a user.

In operation S323, a hot spot may be extracted based on the stress simulation result STR. A hot spot may denote a specific point of a layout having a possibility that an error occurs. Particularly, in some example embodiments, a hot spot may denote a point having a possibility that an error occurs due to stress. As a hot spot is extracted, the stress simulation result STR may be digitized as a stress simulation SVC based on coordinates. The stress simulation value SVC may include coordinates of a position at which the stress occurs, stress, strain, and displacement. The stress simulation value SVC may be extracted as a text file.

As a stress simulation is performed by tile (T of FIG. 4) units, the stress simulation value SVC may be generated by tile (T of FIG. 4) units. All stress simulation values SVC may be combined in a subsequent operation.

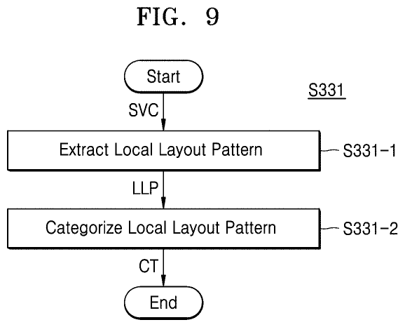

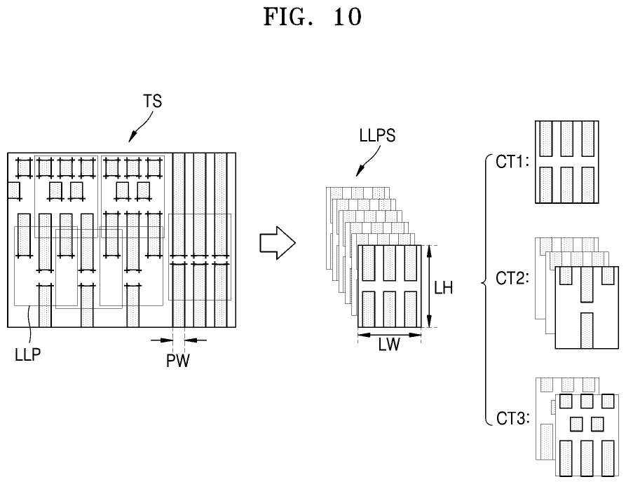

FIGS. 9 and 10 are diagrams for describing a pattern analysis operation according to some example embodiments. In detail, FIG. 9 is a flowchart for describing pattern analysis operation S331 of FIG. 2, and FIG. 10 is a diagram for describing pattern analysis operation S331 of FIG. 2. Hereinafter, a pattern analysis operation according to some example embodiments will be described with reference to FIGS. 1 to 8, and repeated descriptions thereof are omitted.

Referring to FIGS. 9 and 10, pattern analysis operation S331 may include operations S331-1 and S331-2. Operation S331 may be optionally omitted. A user may perform a setting to omit operation S331 through a user interface (16 of FIG. 13), which will be described below with reference to FIG. 13.

In operation S331-1, a local layout pattern LLP may be extracted based on a stress simulation value SVC. The local layout pattern LLP may be defined by disassembling a target shell structure TS according to a variably determined and/or predetermined condition on the basis of the stress simulation value SVC. The condition may be set by the user by using the user interface (16 of FIG. 13), which will be described below with reference to FIG. 13.

A condition may be set, e.g. set by a user, to extract the local layout pattern LLP on the basis of a density, a complexity, an interval, and a size of a layout included in a target shell structure (TS of FIG. 8). For example, the user may disassemble a target shell structure (TS of FIG. 8) at a certain interval, and thus, may set a condition to extract the local layout pattern LLP, set a condition to extract the local layout pattern LLP only when a density of a layout pattern is higher than a certain value, or set a condition to extract the local layout pattern LLP on only patterns having a certain shape.

The local layout pattern LLP may be a portion of the target shell structure TS disassembled or fractured into tetragonal pieces such as square pieces. According to some example embodiments, the local layout pattern LLP may be generated to partially overlap. For example, local layout patterns LLP may be configured to have partially the same pattern.

A width LW of the local layout pattern LLP may be greater than or equal to 10 times a feature value or a minimum value of a width PW of a layout pattern included in the target shell structure TS. The width LW of the local layout pattern LLP may be the same as a height LH of the local layout pattern LLP. However, inventive concepts is not limited thereto, and the width LW and the height LH of the local layout pattern LLP may be variously set.

In operation S331-2, the local layout patterns LLP may be analyzed, and local layout patterns LLP having the same pattern may be categorized. For example, local layout patterns LLP having the same pattern may be categorized as a common category. The number of categories may be differently set according to some example embodiments, and the number of local layout patterns LLP included in each category may differ. For example, one local layout pattern LLP may be categorized in a first category CT1, three local layout patterns LLP may be categorized in a second category CT2, and two local layout patterns LLP may be categorized in a third category CT3. The numbers may each be a number which is set for description, but inventive concepts is not limited thereto.

The local layout pattern LLP may be extracted by tile (T of FIG. 4) units, and local layout patterns LLP categorized as one category may include a local layout pattern LLP extracted in different tiles (T of FIG. 4). Hereinafter, an operation of analyzing stress on each of a case where operation S331 is omitted and a case where operation S331 is not omitted will be described.

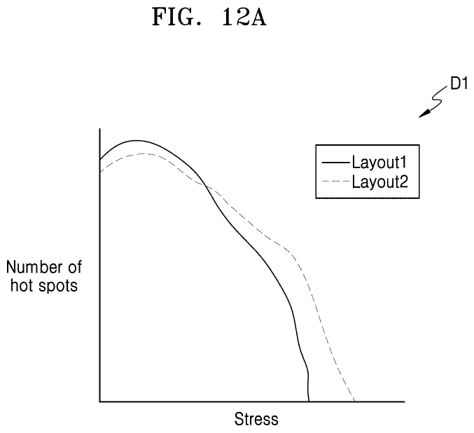

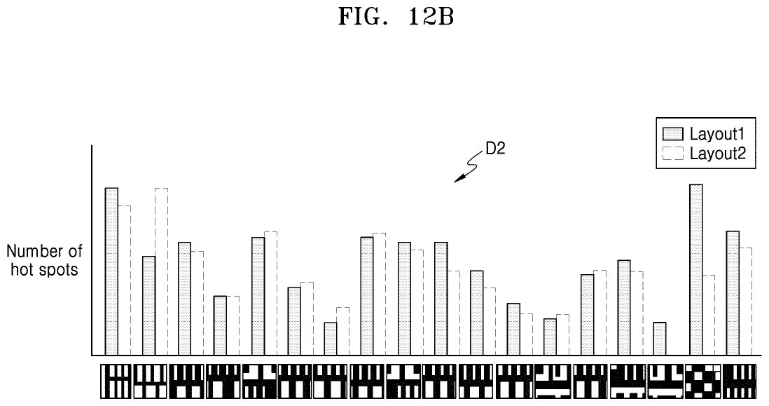

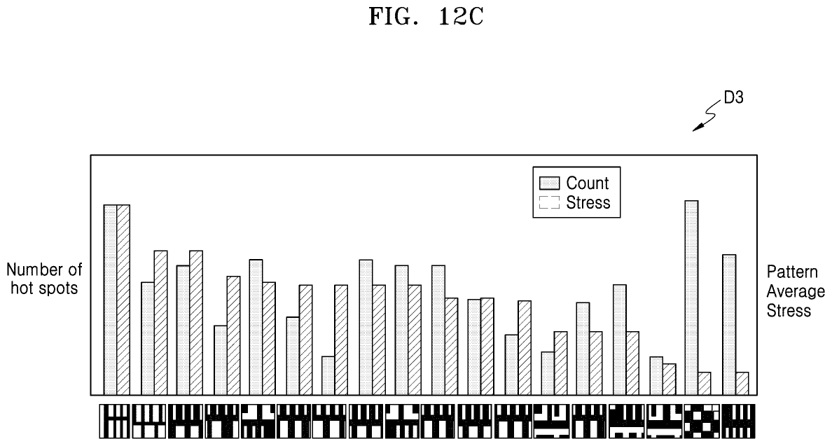

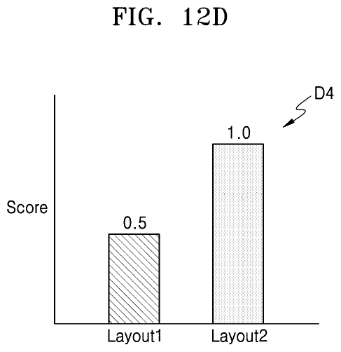

FIGS. 11 and 12A to 12D are diagrams for describing a statistics analysis operation according to some example embodiments. In detail, FIG. 11 is a flowchart for describing statistics analysis operation S332 of FIG. 2, and FIGS. 12A to 12D are diagrams for describing a statistics analysis result. Hereinafter, a statistics analysis operation according to some example embodiments will be described with reference to FIGS. 1 to 10, and repeated descriptions thereof are omitted.

Referring to FIG. 11, statistics analysis operation S332 may include operations S332-1 to S332-6.

In operation S332-1, whether pattern analysis operation S331 has been performed may be determined. As described above, pattern analysis operation S331 may be selectively performed, for example by one or more users. In a case where pattern analysis operation S331 is performed, operation S323_4 may be performed, and in a case where pattern analysis operation S331 is not performed, operation S323_2 may be performed.

In operation S332-2, whether a stress simulation value SVC has to be converted into a layout viewer format may be determined. Whether the stress simulation value SVC has to be converted into the layout viewer format may be determined, for example, by one or more users, who may be the same or different than the one or more users who performed the pattern analysis operation S331. The user may determine whether to convert the stress simulation value SVC into the layout viewer format, by using a user interface (16 of FIG. 13), which will be described below with reference to FIG. 13.

In a case where the stress simulation value SVC has to be converted into the layout viewer format, operation S332-3 may be performed, and in a case where the stress simulation value SVC does not have to be converted into the layout viewer format, operation S332-4 may be performed.

In operation S332-2, based on a selection, for example of the one or more users, only data needed for the stress simulation value SVC may be extracted, or pieces of data may be sorted in ascending power or descending power. For example, only data having a stress value of a certain interval may be extracted on the stress simulation value SVC, and pieces of data having the stress value of a certain interval may be sorted in ascending power or descending power. Stress simulation values SVC may be sorted in ascending power or descending power.

The stress simulation value SVC or data extracted and/or sorted based on a selection of the user may be converted into a format of a layout viewer. The layout viewer may be one of application programs described below with reference to FIG. 13. The layout viewer may be or may include a tool which enables the user to perform various operations by using a layout. The user may perform various operations through the layout viewer by using data converted based on a format of the layout viewer.

For example, as illustrated in FIG. 8, the layout viewer may mark the stress simulation value SVC, extracted in stress simulation operation S320, on a layout pattern. The layout viewer, like the stress simulation value SVC, may display and output the stress simulation value SVC for each node of a target shell structure TS. The layout viewer, as illustrated in FIG. 8, may display “(X-axis position information, Y-axis position information, and a stress value)” for each node of the target shell structure TS. Therefore, the one or more users may more easily analyze the stress simulation value SVC.

In operation S332-4, statistics data of the stress simulation value SVC may be generated. The stress simulation value SVC may be data extracted by tile (T of FIG. 4) units, and the statistics data may be generated by combining all stress simulation values SVC extracted from each tile (T of FIG. 4). That is, the statistics data may include data which is illustrated as a graph by statistically analyzing a plurality of stress simulation values SVC.

Referring to FIG. 12A, first statistics data D1 generated when pattern analysis operation S331 is omitted may be illustrated. When pattern analysis operation S331 is omitted, the first statistics data D1 may be generated by using the stress simulation value SVC, which is extracted in stress simulation operation S320. The first statistics data D1 may include data which is generated by using all stress simulation values SVC extracted from each tile (T of FIG. 4). Therefore, a statistics result of a full-chip layout FCL may be reflected in the first statistics data D1. The first statistics data D1 may be or may include a graph representing a stress value with respect to coordinates corresponding to the full-chip layout FCL. The first statistics data D1 may be or may include a graph where the degree of stress is shown in the X axis and the number of hot spots with respect to the degree of stress is shown in the Y axis.

The first statistics data D1 may be shown to overlap pieces of statistics data extracted from a plurality of layouts. For example, in the first statistics data D1, two pieces of statistics data respectively extracted from two layouts may be shown simultaneously. However, inventive concepts is not limited thereto, and statistics data of a stress value may be a graph where pieces of data extracted from three or more layouts are simultaneously shown.

FIGS. 12B and 12C may respectively show second statistics data D2 and third statistics data D3 generated when pattern analysis operation S331 is performed. The second statistics data D2 and third statistics data D3 may each be statistics data generated for each pattern.

Referring to FIG. 12B, when pattern analysis operation S331 is performed, the second statistics data D2 may be generated by using local layout patterns, which are categorized by categories and are extracted in pattern analysis operation S331. A statistics result based on the catagory and number of local layout patterns LLP may be reflected in the second statistics data D2. The second statistics data D2 may be a graph where a local layout pattern LLP is shown in the X axis thereof and the number of corresponding local layout patterns LLP is shown in the first Y axis thereof. The local layout pattern LLP may be expressed as an image in the X axis (horizontal axis) of the second statistics data D2. As the second statistics data D2 is generated with respect to the local layout pattern LLP, data of a portion of the full-chip layout FCL may be reflected in the second statistics data D2.

The second statistics data D2 may be one graph illustrated so that pieces of data extracted from a plurality of layouts overlap. For example, the second statistics data D2 may compare a plurality of local layout patterns LLP extracted from each of two layouts and may compare the number of local layout patterns LLP including the same pattern. However, inventive concepts is not limited thereto, and pieces of data extracted from three or more layouts may be simultaneously shown in the second statistics data D2.

Referring to FIG. 12C, the third statistics data D3 may be a graph where an average stress value of a local layout pattern LLP is further shown in the second Y axis of the second statistics data D2. That is, in the third statistics data D3, different local layout patterns LLP may be shown in the X axis (or horizontal axis) thereof, the number of local layout patterns LLP having the same pattern may be shown in the first Y axis thereof, and an average, such as at least one of a mean, median, mode, or other measure of central tendency of, stress value of local layout patterns LLP having the same pattern may be shown in the second Y axis thereof. The third statistics data D3 may be shown so that pieces of different data extracted from one layout overlap.

Referring again to FIG. 11, in operation S332-5, whether to output the statistics data generated in operation S332-4 may be determined. The statistics data generated in operation S332-4 may be a histogram. The statistics data generated in operation S332-4 may be pieces of data D1 to D3 described above with reference to FIGS. 12A to 12C. Whether to output the statistics data may be determined by the user.

In operation S332-6, the statistics data (for example, FIG. 12A) generated in operation S332-4 may be additionally analyzed, and statistics data, which has a format that differs from that of the statistics data generated in operation S332-4, may be generated. For example, data may be generated by converting statistics data, extracted from each of a plurality of different full-chip layouts, into a relative score. For example, the relative score may be calculated as an average value of the number of hot spots which occur in a corresponding layout when layout check operation S300 is performed twice or more, on the basis of a plurality of different full-chip layouts. Pieces of data respectively extracted from a plurality of full-chip layouts may be shown to overlap in one graph.

Referring to FIG. 12D, fourth statistics data D4 may be generated based on statistics data respectively extracted from two different layouts.

The fourth statistics data D4 may be a graph where different layouts are shown in the X axis thereof and a score obtained by converting an average value of the number of hot spots, occurring in a corresponding layout, into a relative score is shown in the Y axis thereof. For example, the fourth statistics data D4 may include data where a stress simulation value SVC extracted from each of a plurality of full-chip layouts (FCL of FIG. 4) is converted into a relative score by selectively and additionally analyzing the first statistics data (D1 of FIG. 12A). Whether to perform operation S332-6 may be determined by the user. For example, the user may input a command through a user interface (16 of FIG. 13), which will be described below with reference to FIG. 13. In the fourth statistics data D4, only two layouts are illustrated, but are not limited thereto and three or more layouts may be illustrated.

According to some example embodiments, a layout may be checked by using a full-chip layout, and thus, all or almost all hot spots of the full-chip layout may be detected before a manufacturing operation. Alternatively or additionally, unlike a case where a layout is checked by using a sampled layout, iteration where a check operation is repeatedly performed may be omitted, and thus, a time taken in performing a layout check operation may be reduced. Accordingly there may be an improvement in process time and/or the yield and/or the reliability of semiconductor devices fabricated according to the layout that is checked based on various example embodiments.

FIG. 13 is a block diagram of a layout check system 10 according to some example embodiments. In detail, FIG. 13 is a block diagram of the layout check system 10 for performing the layout check method described above with reference to FIGS. 2 to 12. Hereinafter, the layout check system 10 will be described with reference to FIGS. 2 to 12, like reference numerals refer to like elements, and repeated descriptions thereof are omitted.

Referring to FIG. 13, the layout check system 10 may include a processor 11, a main memory 12, a sub-memory 13, an attachable and detachable storage device 14, a modem 15, a user interface 16, and a bus 17. The layout check system 10 may be a portion of a semiconductor design system. The semiconductor design system may include various designs and check simulation systems. The layout check system 10 may be implemented as a general-use computer or a special-purpose computer for a semiconductor simulation.

The processor 11 may control the layout check system 10 and may perform a simulation for layout check. The processor 11 may execute software performed by the layout check system 10. The software may include an application processor, an operating system, a device driver, etc. The processor 11 may execute an operating system stored in the main memory 12. The processor 11 may execute various application programs driven by the operating system. For example, the processor 11 may execute instructions 13-2 stored in the sub-memory 13 to execute a tool for a simulation. For example, the processor 11 may execute a layout design tool 12-1 stored in the main memory 12. Therefore, the processor 11 may perform a layout check operation (S300 of FIG. 2).

For example, the processor 11 may obtain a semiconductor model for a simulation by using data 13-1 stored in the sub-memory 13. The processor 11 may generate a semiconductor model from the data 13-1 stored in the sub-memory 13 by using the layout design tool 12-1 stored in the main memory 12 and may perform various simulations on the semiconductor model. The processor 11 may extract a simulation value SR by using a simulation model (MA of FIG. 6) stored in the sub-memory 13 and may generate a process condition model (MB of FIG. 6) having a simulation value SR such as a simulation model (MA of FIG. 6). The processor 11 may generate the process condition model (MB of FIG. 6), which matches a simulation model (MA of FIG. 6) based on a process condition (PC of FIG. 5) and is lower in dimension than the simulation model (MA of FIG. 6).

The main memory 12 may include a working memory of the processor 11. The main memory 12 may store an application processor, an operating system, and a device driver, which are executed by the processor 11. For example, the main memory 12 may store the layout design tool 12-1. The layout design tool 12-1 may be an application program for designing a layout. The layout design tool 12-1 may include a bias function for changing shapes and/or positions of certain layout patterns to shapes and/or positions which differ from those designed by a design tool. The layout design tool 12-1 may perform a DRC under a changed bias data condition.

The layout design tool 12-1 may perform a layout check for detecting a hot spot caused by stress. The layout design tool 12-1 may perform a stress simulation (S322 of FIG. 7). The layout design tool 12-1 may be executed by the processor 11. A target shell structure (TS of FIG. 8) may be generated by using the layout design tool 12-1, stress may be analyzed (S322 of FIG. 7), and a hot spot may be detected (S323 of FIG. 7).

The memory 12 may temporarily store the data 13-1 or the instructions 13-2, needed by the processor 11, among the instructions 13-2 and the data 13-1 each stored in the sub-memory 13. The main memory 12 may include at least one of a volatile memory and a non-volatile memory. For example, the main memory 12 may include at least one of read only memory (ROM), programmable ROM (PROM), electrically programmable ROM (EPROM), electrically erasable and programmable ROM (EEPROM), flash memory, phase-change RAM (PRAM), magnetic RAM (MRAM), resistive RAM (ReRAM), ferroelectric RAM (FRAM), dynamic RAM (DRAM), static RAM (SRAM), synchronous DRAM (SDRAM), and ferroelectric RAM (FeRAM).

The sub-memory 13 may include a secondary memory of the layout check system 10. The sub-memory 13 may store the data 13-1 and the instructions 13-2. For example, the sub-memory 13 may store a full-chip layout (FCL of FIG. 4), a process condition (PC of FIG. 5), a simulation model (MA of FIG. 6), and execution instructions of a tool for performing a simulation. The simulation model (MA of FIG. 6) may be transferred to the sub-memory 13 in a format of the data 13-1 through the modem 15 or the attachable and detachable storage device 14. A simulation tool in addition to the layout design tool 12-1 may be transferred to the sub-memory 13 in a format of the instructions 13-2 through the modem 15 or the attachable and detachable storage device 14.

The sub-memory 13 may include a memory card (for example, a multimedia card (MMC), an embedded MMC (eMMC), a secure digital card, and a micro SD card), a hard disk drive (HDD), a solid state drive (SSD), and optical disk drive (ODD)). The sub-memory 13 may include a NAND-type flash memory. However, inventive concepts is not limited thereto, and the sub-memory 13 may alternatively or additionally include NOR flash memory or a next-generation non-volatile memory such as PRAM, MRAM, ReRAM, and FRAM.

The attachable and detachable storage device 14 may include a portable storage. For example, the instructions 13-2 and the data 13-1 each stored in the sub-memory 13 may be transferred from the attachable and detachable storage device 14 to the sub-memory 13. A full-chip layout (FCL of FIG. 4) and at least one process condition (PC of FIG. 5) may be transferred to a sub-memory (13 of FIG. 13) through the attachable and detachable storage device 14. The attachable and detachable storage device 14 may be based on various standards such as universal serial bus (USB) and serial advanced technology attachment (SATA).

The modem 15 may communicate with an external device by wire or wirelessly. For example, the data 13-1 and the instructions 13-2 may be stored in the sub-memory 13 through the modem 15 from the external device. The data 13-1 and the instructions 13-2 each stored in the sub-memory 13 may be transferred to the external device through the modem 15. For example, a full-chip layout (FCL of FIG. 4) and at least one process condition (PC of FIG. 5) may be transferred to a storage (13 of FIG. 13) through a modem (15 of FIG. 13). The modem 15 may be based on Ethernet.

The user interface 16 may receive, from the user, an execution instruction of a tool for a simulation and various instructions for simulation functions of a tool. For example, the user may receive, through the user interface 16, whether to perform a pattern analysis operation (S331 of FIG. 9), whether it is required to convert output data into a layout viewer format (S332-2 of FIG. 11), whether to input a range of data to be output and other settings when converted into the layout viewer format (S332-2 of FIG. 11), and whether to output statistics data (S332-5 of FIG. 11). The user interface 16 may include various user input interfaces such as a touch sensor, a keyboard, a mouse, and a pointing device.

The user interface 16 may transfer a process and a result of a layout check operation (S300 of FIG. 2) to the user. The user interface 16 may include various user output interface devices such as a printer and a layout check method. The user interface 16 may display a result, obtained by performing the layout check operation (S300 of FIG. 2), through the user output interface device. For example, the user interface 16 may display the first to third statistics data D1 to D3, described above with reference to FIGS. 12A to 12D, through an output interface device.

The bus 17 may provide a network in the layout check system 10. The processor 11, the main memory 12, the sub-memory 13, the attachable and detachable storage device 14, the modem 15, and the user interface 16 may be electrically connected to one another through the bus 17 and may exchange data and/or commands therebetween, in a serial and/or parallel manner, communicating in an analog and/or a digital manner

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

While inventive concepts have been particularly shown and described with reference to some example embodiments thereof, it will be understood that various changes in form and details may be made therein without departing from the spirit and scope of the following claims.

1. A layout check method comprising:
generating a layout shell structure by preprocessing a full-chip layout;
generating a process condition model by preprocessing at least one process condition;
extracting a stress simulation value of the layout shell structure by performing a stress simulation based on the layout shell structure and the process condition model; and
extracting statistics data based on the stress simulation value of the layout shell structure, wherein
the layout shell structure and the process condition model have a dimension which is greater than two dimensions and less than three dimensions.

2. The layout check method of claim 1, wherein the generating of the layout shell structure comprises:
generating a tile layout by disassembling the full-chip layout into a plurality of tiles;
extracting a polygon based on parsing performed on each of the plurality of tiles;
generating a polygon mesh corresponding to each of the plurality of tiles by generating a mesh based on the polygon; and
generating the layout shell structure by assigning a virtual height to the polygon mesh.

3. (canceled)

4. The layout check method of claim 1, wherein the generating of the process condition model comprises:
extracting a simulation value by applying the at least one process condition to a three-dimensional simulation model; and
generating a process condition model which is configured to output a same value as the simulation value and has a virtual height corresponding to the three-dimensional simulation model.

5. The layout check method of claim 1, wherein the extracting of the stress simulation value comprises:
generating a target shell structure by applying the process condition model to the layout shell structure; and
extracting the stress simulation value by performing a stress simulation on the basis of the target shell structure.

6. The layout check method of claim 1, wherein the extracting of the stress simulation value comprises extracting information about at least one of coordinates, a stress value, strain, and displacement each corresponding to a position at which stress occurs.

7. The layout check method of claim 1, wherein the extracting of the statistics data comprises generating statistics data of the full-chip layout by performing statistics analysis based on the stress simulation value.

8. The layout check method of claim 7, wherein the extracting of the statistics data comprises:
selectively converting the stress simulation value into a layout viewer format; and
generating additional data, where the statistics data extracted from each of a plurality of different full-chip layouts is converted into a relative score, by selectively and additionally analyzing the statistics data.

9. The layout check method of claim 1, wherein the extracting of the statistics data comprises:
performing pattern analysis based on the stress simulation value; and
generating statistics data for each pattern by performing statistics analysis based on a result obtained by performing the pattern analysis.

10. The layout check method of claim 9, wherein the performing of the pattern analysis comprises:
extracting a plurality of local layout patterns on based on the stress simulation value; and
categorizing the plurality of local layout patterns for each local layout pattern having a same pattern.

11. A layout check method comprising:
generating a tile layout by disassembling a full-chip layout into a plurality of tiles;
generating a layout shell structure on each of the plurality of tiles, the layout shell structure having a virtual height;
generating a process condition model by using at least one process condition and a three-dimensional simulation model, the process condition model having the virtual height;
generating a plurality of target shell structures by applying the process condition model to the layout shell structure; and
extracting stress simulation values respectively corresponding to the plurality of target shell structures by performing a stress simulation on each of the plurality of target shell structures.

12. The layout check method of claim 11, wherein the generating of the layout shell structure comprises:
performing parsing on each of the plurality of tiles to convert each of the plurality of tiles into a coding language and to extract node and coordinate information from a layout pattern included in each of the plurality of tiles;
extracting at least one polygon from each of the plurality of tiles based on the node and coordinate information;
generating at least one polygon mesh corresponding to each of the plurality of tiles by generating a mesh based on the at least one polygon; and
generating the layout shell structure by assigning the virtual height to the polygon mesh.

13. The layout check method of claim 11, wherein the generating of the process condition model comprises:
extracting a simulation value including information about intrinsic stress and physical properties, the extracting the simulation value by applying the at least one process condition to a three-dimensional simulation model; and
generating the process condition model which is configured to output a same value as the simulation value and has a same structure as the three-dimensional simulation model.

14. (canceled)

15. The layout check method of claim 11, wherein the extracting of the stress simulation values comprises extracting information about coordinates, stress, strain, and displacement each corresponding to a position at which stress occurs, in each of the plurality of target shell structures.

16. The layout check method of claim 11, further comprising:
extracting statistics data based on stress simulation values respectively corresponding to the plurality of target shell structures; and
generating additional data, where the statistics data extracted from each of a plurality of different full-chip layouts is converted into a relative score, by selectively and additionally analyzing the statistics data.

17. The layout check method of claim 16, further comprising:
extracting a plurality of local layout patterns based on the stress simulation values;
categorizing the plurality of local layout patterns for each local layout pattern having the same pattern; and
extracting the statistics data based on the categorized plurality of local layout patterns.

18. A layout check system comprising:
a sub-memory configured to store data and computer-readable instructions, the data including a full-chip layout, process conditions, and a three-dimensional simulation model and the instructions including executions instructions of a tool for performing a stress simulation;
a main memory configured to store the tool for performing the stress simulation; and
a processor configured to generate a layout shell structure having a virtual height based on a tile layout where the full-chip layout is disassembled into a plurality of tiles, to generate a process condition model having a virtual height based on at least one of the process conditions and the three-dimensional simulation model, and to perform the stress simulation by using a target shell structure generated by applying the process condition model to the layout shell structure.

19. The layout check system of claim 18, wherein the processor is configured to generate a polygon mesh based on a polygon extracted by performing parsing on each of the plurality of tiles and generate the layout shell structure by assigning a virtual height to the polygon mesh.

20. The layout check system of claim 18, wherein the process conditions comprise at least one of a temperature of a process, a time of the process, a structure of a semiconductor device, and physical properties applied in manufacturing the semiconductor device by using the full-chip layout, and
the process condition model is configured to have the same structure as the three-dimensional simulation model and have the same result value as a simulation result value extracted when at least one of the process conditions is applied to the three-dimensional simulation model.

21. The layout check system of claim 18, wherein the processor is configured to perform the stress simulation by tile units to extract stress simulation values including information about coordinates, stress, strain, and displacement, each corresponding to a position at which the stress occurs, and
generate statistics data based on the stress simulation values extracted by tile units.

22. The layout check system of claim 21, wherein the processor is configured to extract a plurality of local layout patterns based on the stress simulation value, categorize the plurality of local layout patterns for each local layout pattern having the same pattern, and
generate the statistics data based on the categorized plurality of local layout patterns.

23. (canceled)

24. (canceled)
